(19) United States
(12) Patent Application Publication
(10) Pub. No.: US 2006/0042472 A1
(43) Pub. Date: Mar. 2, 2006

(54) Popcorn popper

(76) Inventor: Angela Marie Shore, Charlotte, NC (US)

Correspondence Address: Adams Evans P.A., 2180 Two Wachovia Center, 301 S. Tryon Street, Charlotte, NC, 28282, US

(21) Appl. No.: 11/205,512

(22) Filed: Aug. 17, 2005

Related U.S. Application Data
(60) Provisional application No. 60/603,859, filed on Aug. 24, 2004.

(51) Int. Cl. A23L 1/18

(52) U.S. Cl. 99/323.5

(57) ABSTRACT

A popcorn popper including a base and a mating cover. The base includes a popping chamber for popping corn, a channel surrounding the popping chamber for receiving popped and un-popped corn, and a heating apparatus for heating and forcing air into the popping chamber. The mating cover is supported by the base for enclosing and directing heated air exiting the popping chamber to the channel for heating the popped and un-popped corn in the channel and ensure that the corn is fully popped.

This application claims the benefit of Provisional Application No. 60/603,859 filed on Aug. 24, 2004.

### TECHNICAL FIELD AND BACKGROUND OF THE INVENTION

This invention relates to a popcorn popper and more specifically to a popcorn popper having a cover that is releasably secured to a base, that glows when the popcorn popper is in use, and that acts as a bowl when the popping process is finished.

Popcorn poppers of varying types are well-known in the art. Many popcorn poppers use heated oil to produce popcorn, while other popcorn poppers use heated air. For example, U.S. Pat. No. 4,445,427 to Kiczek discloses a popcorn popper. The popcorn popper uses oil which is heated to a popping temperature to produce popcorn. The popcorn popper includes a cover which is used to deflect the popcorn into a receptacle. Once the corn has been popped and the popcorn popper has cooled the popcorn popper is turned upside-down allowing the cover to be used as a bowl.

U.S. Pat. No. 4,702,158 to Ishihara discloses a popcorn popper having improved heated air flow. The popcorn popper uses a popping chamber heated by air which is directed through holes in a bottom of the chamber to produce popcorn. The popcorn is ejected from the popper through an opening in a chute-type cover.

U.S. Pat. No. 5,501,139 to Lee discloses a popcorn maker. The popcorn maker uses a popping chamber heated by air which is blown into the chamber by a fan. A flap is used to prevent any unpopped corn from reaching a discharge outlet. The flap is opened by a build up of popped corn to allow the popped corn to discharge.

While these poppers are capable of popping corn, they do not provide a popper that is attractive whether or not it is being used, and that allows the popper to be safely turned upside-down without separating.

### SUMMARY OF THE INVENTION

Therefore, it is an object of the invention to provide a popcorn popper with a cover that is releasably secured to a base.

It is another object of the invention to provide a popcorn popper that can be removed from a doughnut-shaped support and turned upside-down without the base and cover separating.

It is another object of the invention to provide a popcorn popper that has a light emitting diode (“LED”) in a groove on a top edge of the base to provide a glowing effect to the cover.

It is another object of the invention to provide a cover that remains cool to the touch.

These and other objects of the present invention are achieved in the preferred embodiments disclosed below by providing a popcorn popper including a base and a mating cover. The base includes a popping chamber for popping corn, a channel surrounding the popping chamber for receiving popped and un-popped corn, and a heating apparatus for heating and forcing air into the popping chamber. The mating cover is supported by the base for enclosing and directing heated air exiting the popping chamber to the channel for heating the popped and un-popped corn in the channel and ensure that the corn is fully popped.

According to another preferred embodiment of the invention, the cover includes spaced-apart outer and inner shells forming an air chamber therebetween for providing an insulating layer of air to provide a cool outer shell during operation.

According to another preferred embodiment of the invention, the base includes a pair of handles, the handles being moveable between a secure position where the handles engage a respective lip formed along a bottom edge of the cover to secure the cover to the base and a release position where the handles disengage the lip to allow the cover to be removed from the base.

According to another preferred embodiment of the invention, the base and cover include recesses positioned on opposing sides cooperating with the handles to allow easy access to the handles.

According to another preferred embodiment of the invention, a light source is positioned in a groove along a top edge of the base for providing a glowing effect to the cover.

According to another preferred embodiment of the invention, the heating apparatus includes a fan and a heating element.

According to another preferred embodiment of the invention, the base is generally hemispherical in shape.

According to another preferred embodiment of the invention, the cover is generally hemispherical in shape.

According to another preferred embodiment of the invention, a popcorn popper includes a base and a mating cover. The base includes a popping chamber for popping corn, a channel surrounding the popping chamber for receiving popped and un-popped corn, a heating apparatus for heating the popping chamber, and at least two handles positioned on opposing sides of the base for lifting the base. The mating cover is supported by the base for enclosing the popping chamber. The cover includes at least two lips adapted to be engaged by the at least two handles so as to secure the cover to the base.

According to another preferred embodiment of the invention, the handles are moveable between a secure position where the handles engage the lips to secure the cover to the base and a release position where the handles disengage the lips to allow the cover to be removed from the base.

According to another preferred embodiment of the invention, a method for popping corn includes providing a popcorn popper having a base, a mating cover, a popping chamber, a channel surrounding the popping chamber, and a heating apparatus for providing heated air; placing un-popped corn into the popping chamber; forcing heated air into the popping chamber to pop the un-popped corn and to force popped corn out of the popping chamber and into the channel; and recirculating heated air from the popping chamber to the corn in the channel.

According to another preferred embodiment of the invention, some of the un-popped corn enters the channel, and at least a portion of the un-popped corn is popped by the recirculated heated air.

According to another preferred embodiment of the invention, the method of popping corn further includes the step of turning the popcorn popper upside down and resting the cover on a support.

According to another preferred embodiment of the invention, the method of popping corn further includes the step of removing the base from the cover and using the cover as a bowl.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a popcorn popper according to a preferred embodiment of the invention;

FIG. 2 is another perspective view of the popcorn popper of FIG. 1;

FIG. 3 is a top plan view of the popcorn popper;

FIG. 4 shows an internal fan and heating coil for popping corn in the popcorn popper;

FIG. 5 shows an electrical cord plugged into the base;

FIG. 6 shows a donut-shaped support for the base;

FIG. 7 is a partial perspective view of a top edge of the base;

FIG. 8 shows a side cross-section of the cover;

FIG. 9 is a partial perspective view of a handle on a side of the base;

FIG. 10 shows a cover and base of the popcorn popper separated; and

FIG. 11 shows the air-flow produced by the internal fan of FIG. 4.

### DESCRIPTION OF THE PREFERRED EMBODIMENT AND BEST MODE

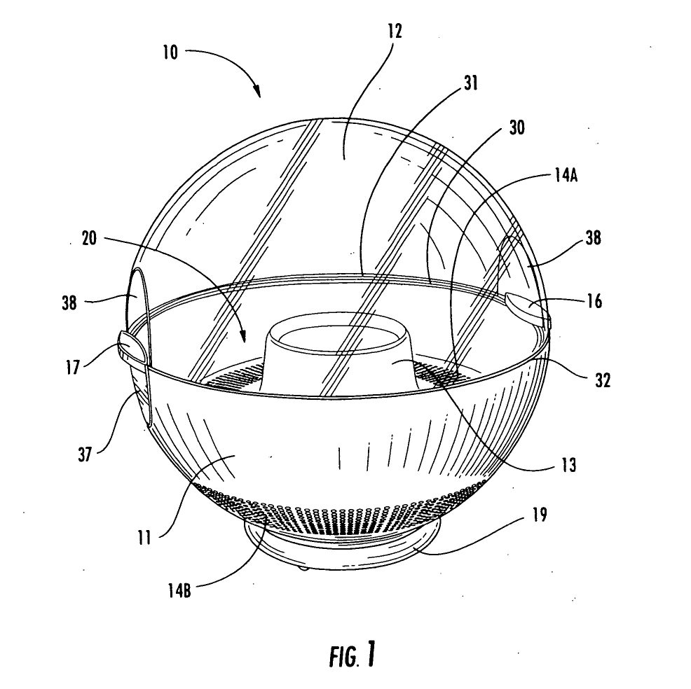

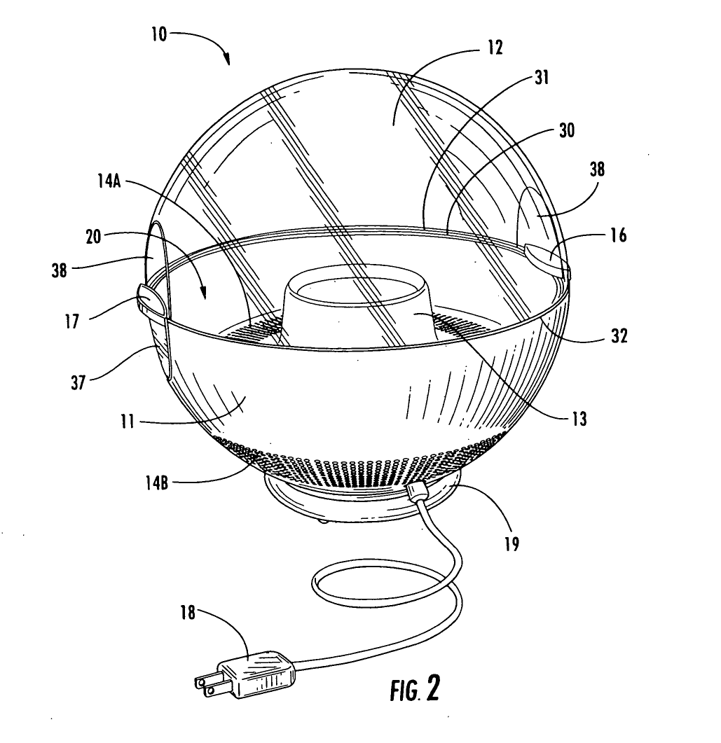

Referring now specifically to the drawings, a popcorn popper according to an embodiment of the present invention is illustrated in FIGS. 1 and 2 and shown generally at reference numeral 10.

The popcorn popper 10 includes a hemispherical base 11 and a hemispherical cover 12 supported by the base 11. The base 11 includes a popping chamber 13, two arrays of exhaust vents 14A and 14B positioned in the base 11. Exhaust vent 14A directs the heated air from inside the popcorn popper 10 to exhaust vent 14B where the heated air exits the base.

A pair of spring-biased handles 16 and 17 are positioned on opposing sides of the base 11. An electrical cord 18 for connection to an electrical power source is also connected to the base 11. The popcorn popper 10 is supported by a detachable doughnut-shaped support ring 19.

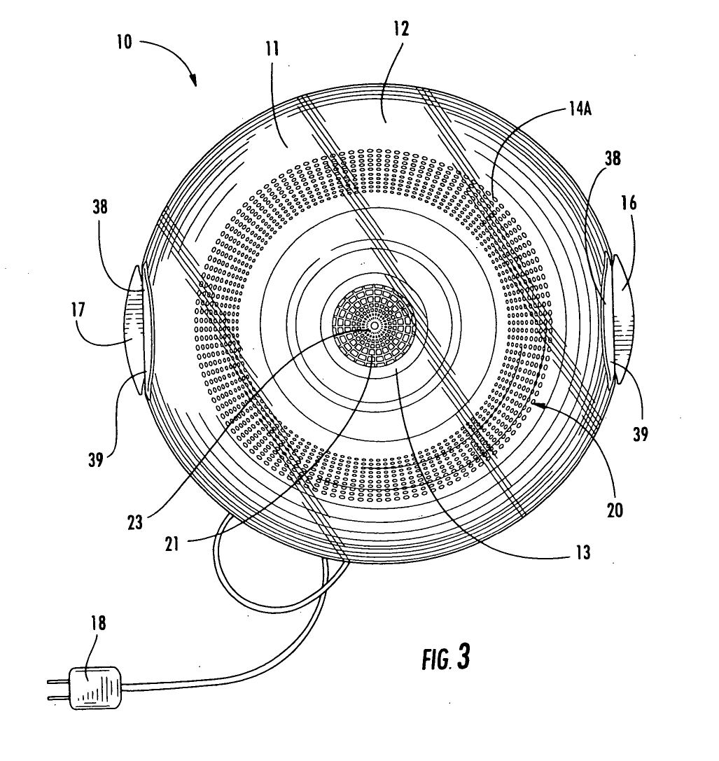

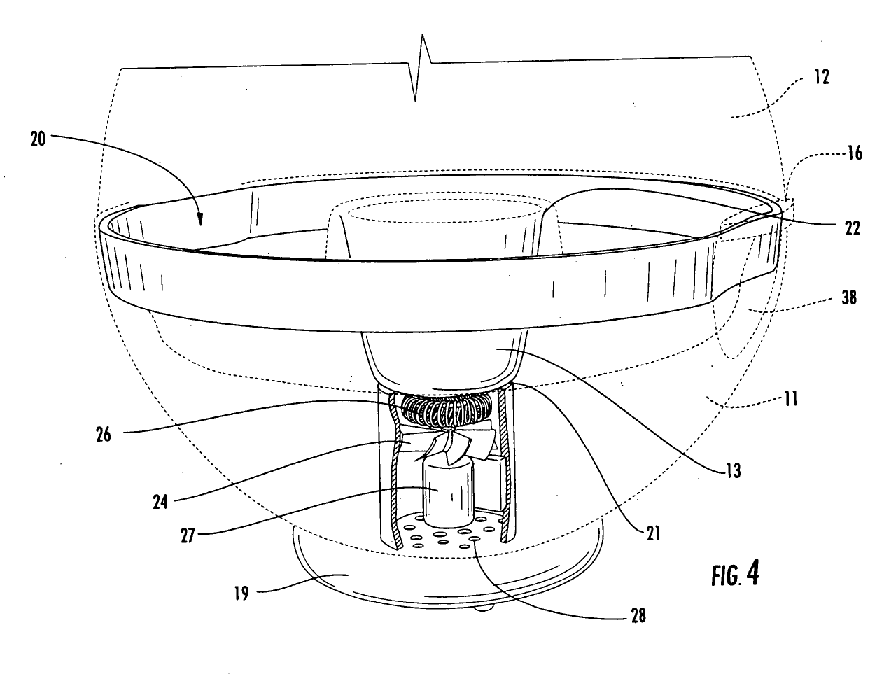

Referring to FIGS. 3 and 4, the popping chamber 13 is positioned in the center of the base 11 and surrounded by a channel 20. The popping chamber 13 has a tapered cup-like shape with a bottom 21 having a smaller diameter than a top 22. The bottom 21 includes an air diffuser 23 for directing heated air into the popping chamber 13.

Heated air is supplied by a fan 24 and a heating element 26 positioned below the popping chamber 13. The fan 24 is rotated by a motor 27. The fan 24 pulls air from a plurality of intake vents 28 and forces the air past the heating element 26 to provide the heated air necessary for popping the corn.

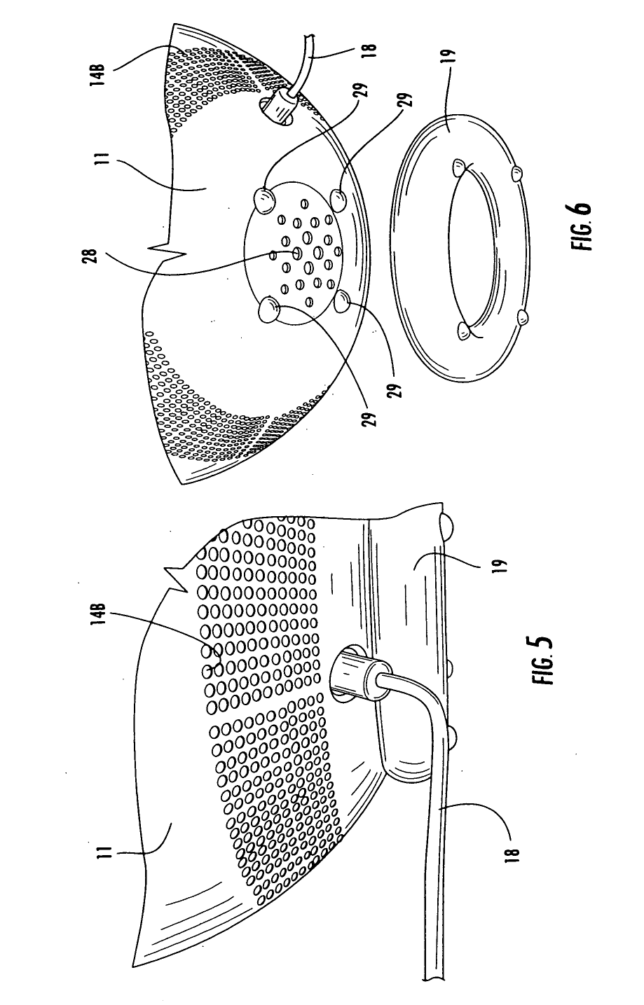

As shown in FIG. 5, the electrical cord 18 is releasably secured to the base 11, and can be removed from the base 11 for storage.

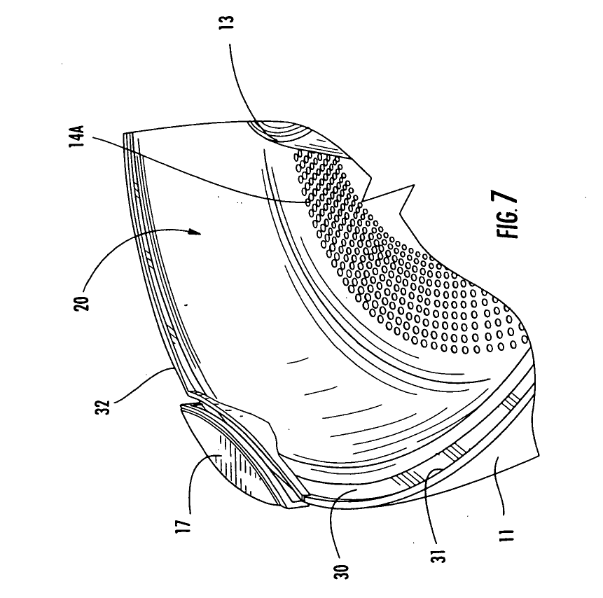

Referring to FIG. 6, the base 11 includes four feet 29 to allow the base 11 to be safely supported on a surface without the use of the support ring 19.

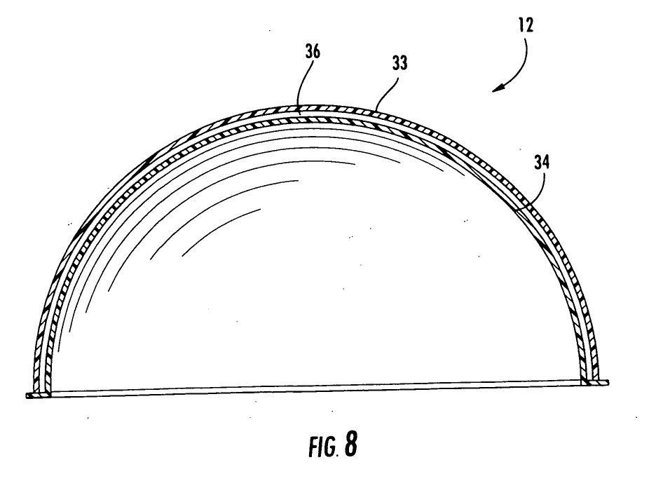

As illustrated in FIG. 7, the base 11 includes a light emitting diode tube (“LED”) 30 positioned in a groove 31 along a top edge 32 of the base 11. The “LED” 30 emits a light that is received by the cover 12 to provide a glowing effect to the cover 12. The “LED” 30 is connected to the same switch (not shown) as the motor 27, so that the “LED” 30 only operates when the popcorn popper 10 is operating.

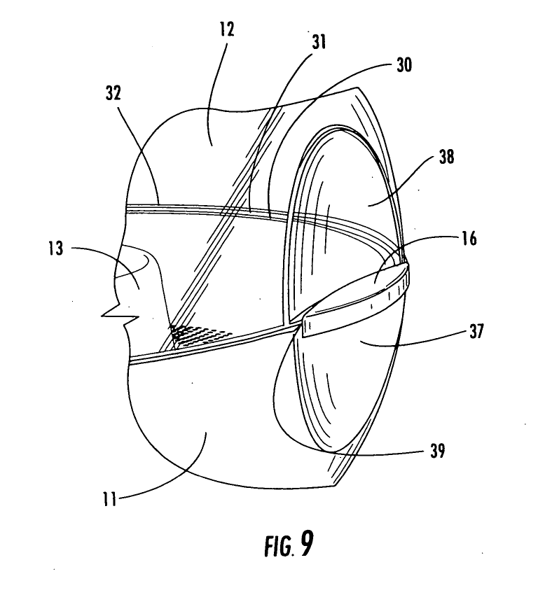

Referring to FIG. 8, the cover 12 is formed from a transparent plastic capable of withstanding high temperatures produced by the popcorn popper 10. The cover 12 has an outer shell 33 and an inner shell 34 forming an air chamber 36 therebetween. The air chamber 36 provides an insulating layer of air for reducing the amount of heat that comes in contact with the outer shell 33, reducing the temperature of the outer shell 33 during operation and preventing an individual from being burned.

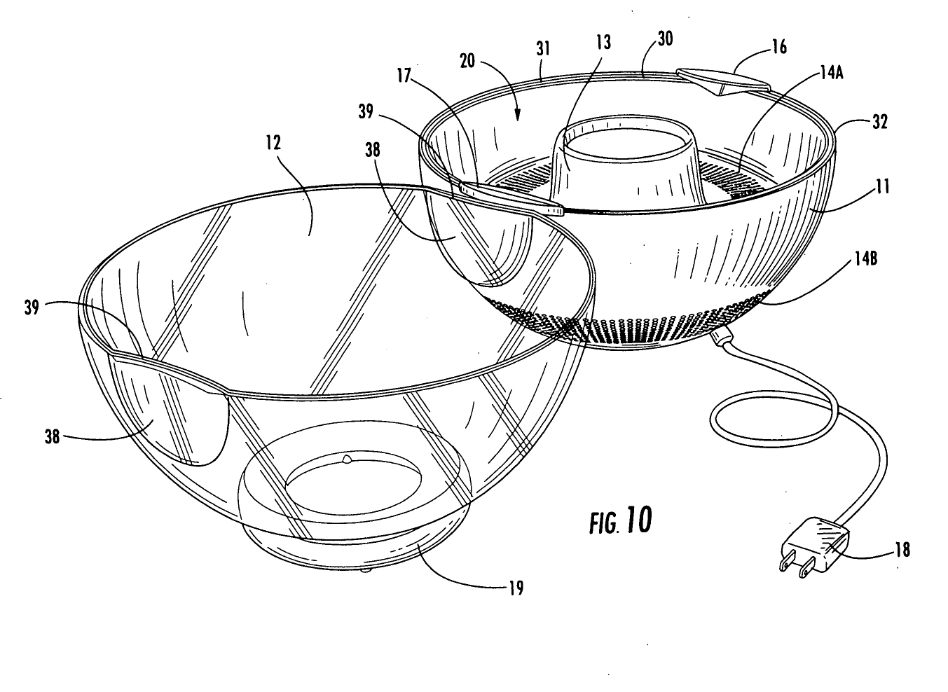

Referring to FIGS. 1 and 9, the cover 12 and base 11 are secured together by the handles 16 and 17. The base 11 includes concave recesses 37 positioned on opposing sides. The recesses 37 allow an individual to more easily pick up the popcorn popper 10 using the handles 16 and 17.

The cover 12 also includes concave recesses 38 positioned on opposing sides of the cover 12. The recesses 38 provide lips 39 for being engaged by the handles 16 and 17 for securing the cover 12 to the base 11.

The handles 16 and 17 are spring-loaded to allow movement from a secured position to a release position. The cover 12 is secured to the base 11 by positioning each of the lips 39 in relation to the handles 16 and 17. The cover 12 is then snapped into place allowing the handles 16 and 17 to engage a corresponding lips 39. Once the handles 16 and 17 have engaged the respective lips 39, the popcorn popper 10 can be safely turned upside-down without the cover 12 separating from the base 11. The cover 12 is released from the base 11 by pulling the handles 16 and 17 outwardly from the base 11 to the release position, thereby disengaging the handles 16 and 17 from the respective lips 39.

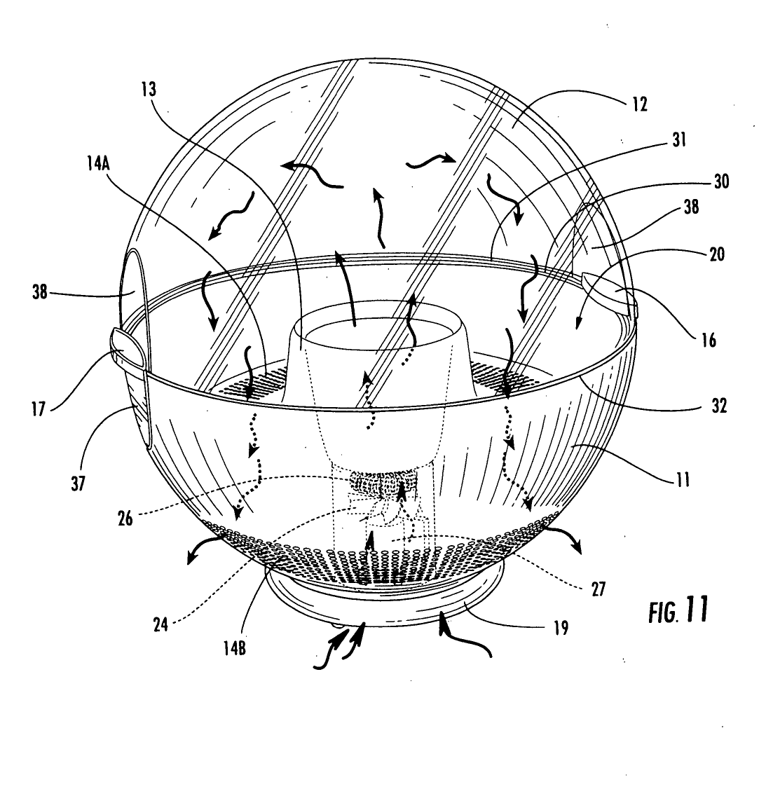

Referring now to FIG. 10, the cover 12 can be used as a bowl for the popped corn. The support ring 19 is removed from the base 11 and positioned to receive and support the cover 12. The popcorn popper 10 is turned upside-down so that the cover 12 rests on the support ring 19. The cover 12 is then released from the base 11 by moving the handles 16 and 17 to a release position.

Referring to FIG. 11, in operation, the popcorn popper 10 uses heated air to pop kernels of corn and produce popped corn. The fan 24 pulls air from underneath the base 11 through the intake vents 28 and forces the air past the heating element 26. The heating element 26 heats the air to a temperature required for popping the kernels of corn. The heated air is forced into the popping chamber 13 through the diffuser 23 where the heated air makes contact with the kernels of corn.

The heated air exits the popping chamber 13 and is deflected by the cover 12 to the exhaust vents 14A positioned in the channel 20. The heated air is then diverted to the exhaust vents 14B where it exits the base 11. The flow path of the air forces the popped corn to exit the heating chamber 13 and come to rest in the channel 20 surrounding the popping chamber 13. As the popped corn rests in the channel 20, the heated air continues to make contact with the popped corn as the heated air exits the popcorn popper 10 through the exhaust vents 14A and 14B, ensuring that the corn is fully popped. The flow path of the air also helps ensure that all of the kernels are popped. If a kernel of corn escapes the popping chamber 13 before being popped, the continuing flow of heated air over the kernel pops the kernel, thereby reducing the number of un-popped kernels.

A popcorn popper is described above. Various details of the invention may be changed without departing from its scope. Furthermore, the foregoing description of the preferred embodiment of the invention and the best mode of practicing the invention are provided for the purpose of illustration only and not for the purpose of limitation.

I claim:

1. A popcorn popper, comprising:
(a) a base, having:
(i) a popping chamber for popping corn;
(ii) a channel surrounding the popping chamber for receiving popped and un-popped corn;
(iii) a heating apparatus for heating and forcing air into the popping chamber; and
(b) a mating cover supported by the base for enclosing and directing heated air exiting the popping chamber to the channel for heating the popped and un-popped corn in the channel and ensure that the corn is fully popped.

2. The popcorn popper according to claim 1, wherein the cover includes spaced-apart outer and inner shells forming an air chamber therebetween for providing an insulating layer of air to provide a cool outer shell during operation.

3. The popcorn popper according to claim 1, wherein the base includes a pair of handles, the handles being moveable between a secure position where the handles engage a lip formed along a bottom edge of the cover to secure the cover to the base and a release position where the handles disengage the lip to allow the cover to be removed from the base.

4. The popcorn popper according to claim 3, wherein the base and cover each include recesses positioned on opposing sides cooperating with the handles to allow easy access to the handles.

5. The popcorn popper according to claim 1, wherein a light source is positioned in a groove along a top edge of the base for providing a glowing effect to the cover.

6. The popcorn popper according to claim 1, wherein the heating apparatus includes a heating element for producing heat and a fan for forcing air over the heating element and into the popping chamber.

7. The popcorn popper according to claim 1, wherein the base is generally hemispherical in shape.

8. The popcorn popper according to claim 1, wherein the cover is generally hemispherical in shape.

9. A popcorn popper, comprising:
(a) a base, having:
(i) a popping chamber for popping corn;
(ii) a channel surrounding the popping chamber for receiving popped and un-popped corn;
(iii) a heating apparatus for heating the popping chamber;
(iv) at least two handles positioned on opposing sides of the base for lifting the base; and
(b) a mating cover supported by the base for enclosing the popping chamber, the cover including at least two lips adapted to be engaged by the at least two handles so as to secure the cover to the base.

10. The popcorn popper according to claim 9, wherein the cover includes spaced-apart outer and inner shells forming an air chamber therebetween for providing an insulating layer of air to provide a cool outer shell during operation.

11. The popcorn popper according to claim 9, wherein the handles are moveable between a secure position where the handles engage the lips to secure the cover to the base and a release position where the handles disengage the lips to allow the cover to be removed from the base.

12. The popcorn popper according to claim 9, wherein the heating apparatus includes a heating element for producing heat and a fan for forcing air over the heating element and into the popping chamber.

13. The popcorn popper according to claim 9, wherein the base and cover each include recesses positioned on opposing sides cooperating with the handles to allow easy access to the handles.

14. The popcorn popper according to claim 9, wherein a light source is positioned in a groove along a top edge of the base for providing a glowing effect to the cover.

15. The popcorn popper according to claim 9, wherein the cover is generally hemispherical in shape.

16. The popcorn popper according to claim 9, wherein the base is generally hemispherical.

17. A method for popping corn, comprising:
(a) providing a popcorn popper having a base, a mating cover, a popping chamber, a channel surrounding the popping chamber, and a heating apparatus for providing heated air;
(b) placing un-popped corn into the popping chamber;
(c) forcing heated air into the popping chamber to pop the un-popped corn and to force popped corn out of the popping chamber and into the channel; and
(d) recirculating heated air from the popping chamber to the corn in the channel.

18. The method according to claim 17, wherein some of the un-popped corn enters the channel, and at least a portion of the un-popped corn is popped by the recirculated heated air.

19. The method according to claim 17, and further including the step of turning the popcorn popper upside down and resting the cover on a support.

20. The method according to claim 19, and further including the step of removing the base from the cover and using the cover as a bowl.
